(19) United States
(12) Patent Application Publication
(10) Pub. No.: US 2026/0047967 A1
(43) Pub. Date: Feb. 19, 2026

(54) Expandable Wheelchair Device

(71) Applicant: Pierre Charles, East Patchogue, NY (US)

(72) Inventor: Pierre Charles, East Patchogue, NY (US)

(21) Appl. No.: 18/804,625

(22) Filed: Aug. 14, 2024

(51) Int. Cl. A61G 5/10; A61G 5/12

(52) U.S. Cl. CPC A61G 5/1067; A61G 5/1064; A61G 5/1091; A61G 5/121; A61G 5/125; A61G 5/127; A61G 5/128

(57) ABSTRACT

An expandable wheelchair device for adjusting dimensions of the wheelchair to accommodate variously sized users includes a chair having a seat and a back rest. The seat includes a pair of seat rods that are each extendable and retractable. The back rest includes a pair of back rest rods that are each extendable and retractable. A support is positioned beneath the seat to support the chair above a surface. A pair of drive wheels is rotatably coupled to the support proximate to a junction between the seat and the back rest. A pair of front wheels is rotatably coupled to the support and is spaced from the pair of drive wheels.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention.

The disclosure relates to wheelchairs and more particularly pertains to a new wheelchair for adjusting dimensions of the wheelchair to accommodate variously sized users.

### (2) Description of Related Art including information disclosed under 37 CFR 1.97 and 1.98.

The prior art relates to wheelchairs. Wheelchairs are a commonly used device for individuals with mobility restrictions or disabilities. Conventional wheelchairs are designed based on an expected or average size of the user. For example, when a user is purchasing a wheelchair, the user may decide between various models based on the dimensions of each model. Users thus typically need to try out various sizes of chairs, to find the right fit. This can be an expensive and time consuming process which is not reasonable, or even viable, in many situations. Additionally, suppliers such as hospitals and occupational or physical therapy centers are forced to keep a stockpile of variously sized wheelchairs, which can require a significant amount of storage space. Thus, there is a need for a wheelchair having adjustable dimensions so that a single model of the wheelchair can accommodate various sizes of users.

### BRIEF SUMMARY OF THE INVENTION

An embodiment of the disclosure meets the needs presented above by generally comprising a chair having a seat and a back rest. The seat includes a pair of seat rods that are spaced from each other. Each seat rod of the pair of seat rods is extendable and retractable to adjust a length of the pair of seat rods. The back rest includes a pair of back rest rods that are spaced from each other. Each back rest rod of the pair of back rest rods is extendable and retractable to adjust a length of the pair of back rest rods. A support is coupled to the seat of the chair. The support is positioned beneath the seat wherein the support is configured to support the chair above a surface. A pair of drive wheels is rotatably coupled to the support. The pair of drive wheels is positioned proximate to a junction between the seat and the back rest. A pair of front wheels is rotatably coupled to the support. The pair of front wheels is spaced from the pair of drive wheels.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1a is a front isometric view of an expandable wheelchair device according to an embodiment of the disclosure.

FIG. 1b is a front isometric view of an embodiment of the disclosure.

FIG. 2 is a side view of an embodiment of the disclosure.

FIG. 3 is a side view of an embodiment of the disclosure.

FIG. 4 is a detail view of an embodiment of the disclosure.

FIG. 5 is a detail view of an embodiment of the disclosure.

FIG. 6 is a rear view of an embodiment of the disclosure.

FIG. 7 is a front view of an embodiment of the disclosure.

FIG. 8 is a top view of an embodiment of the disclosure.

FIG. 9 is an in-use view of an embodiment of the disclosure.

FIG. 10 is an in-use view of an embodiment of the disclosure.

FIG. 11 is a detail view of an embodiment of the disclosure.

FIG. 12 is a side view of an embodiment of the disclosure.

### DETAILED DESCRIPTION OF THE INVENTION

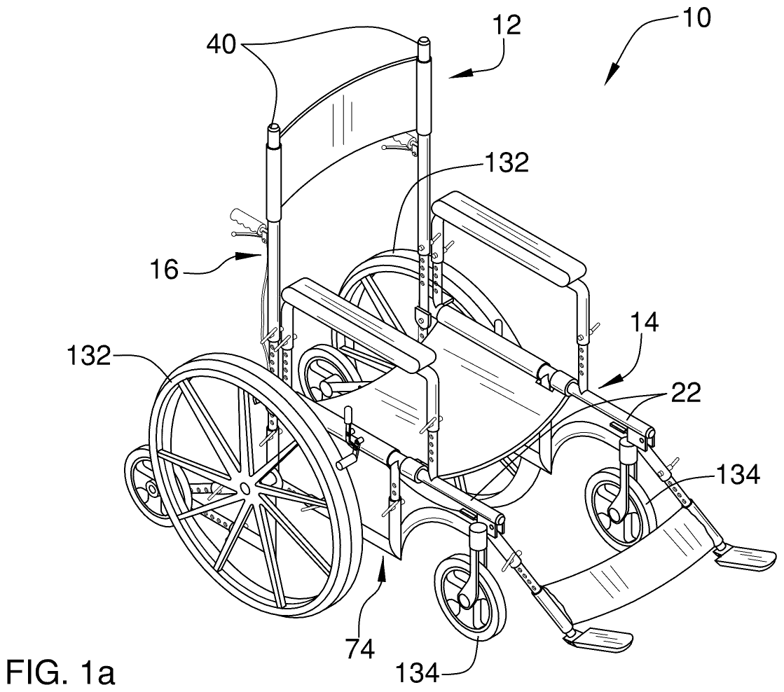

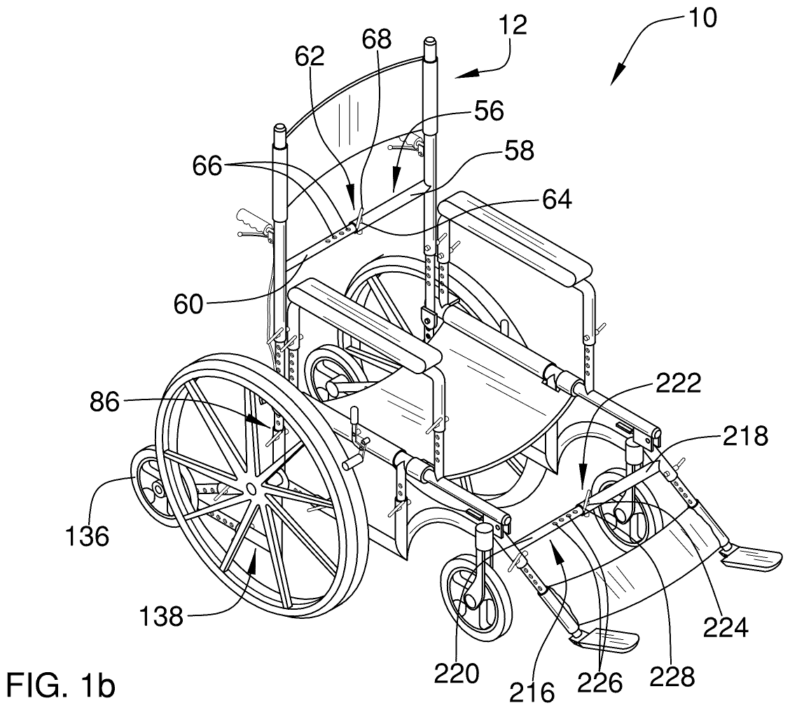

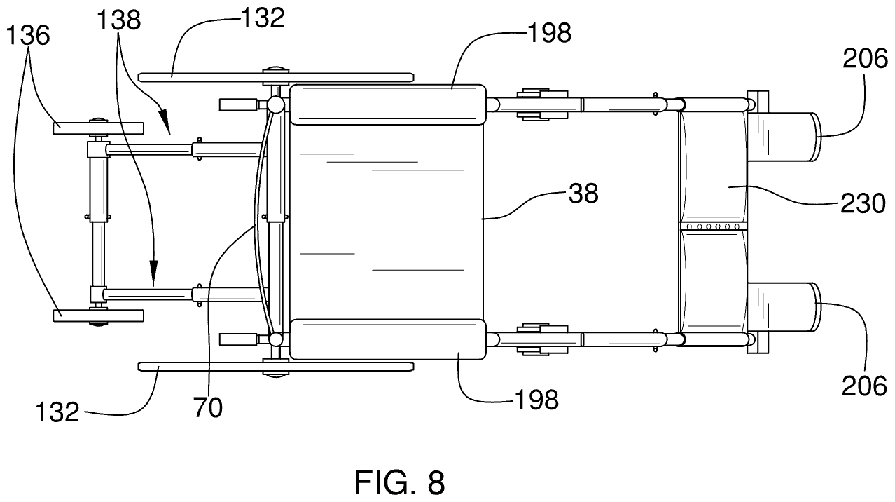

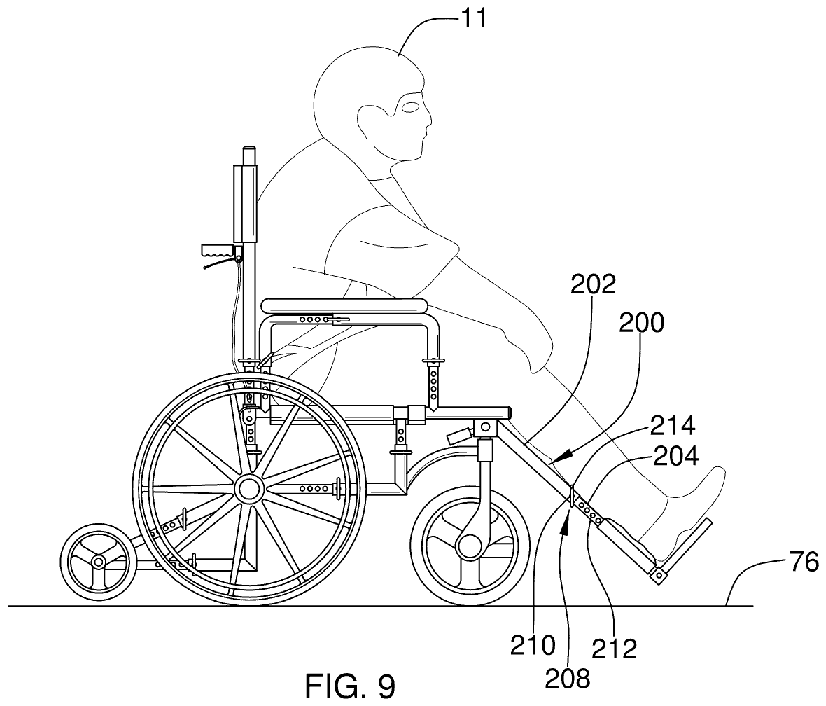

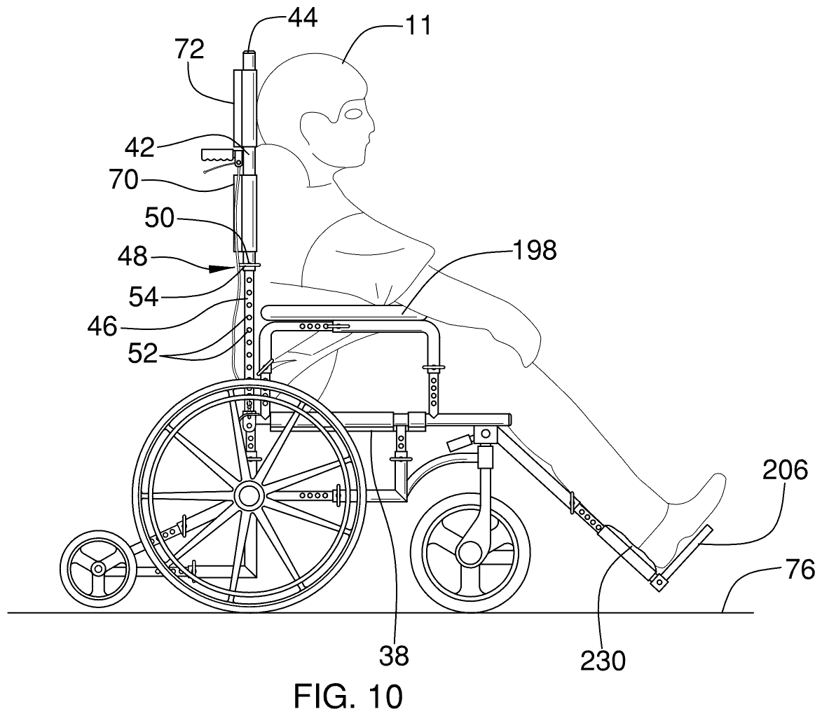

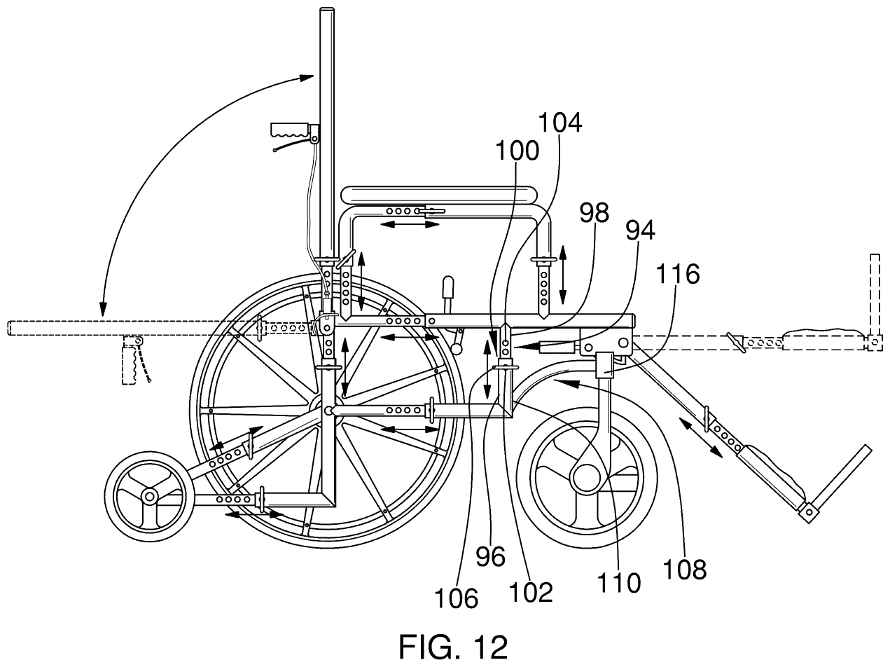

With reference now to the drawings, and in particular to FIGS. 1 through 12 thereof, a new wheelchair embodying the principles and concepts of an embodiment of the disclosure and generally designated by the reference numeral 10 will be described.

As best illustrated in FIGS. 1 through 12, the expandable wheelchair device 10 generally comprises a chair 12 which has a seat 14 and a back rest 16. The back rest 16 is coupled to the seat 14. The back rest 16 may be pivotably coupled to the seat 14 wherein the back rest 16 is pivotable between an upright position 18 and a reclined position 20. The back rest 16 may extend upward from the seat 14 when the back rest 16 is in the upright position 18. For example, the back rest 16 may be perpendicular to the seat 14 when the back rest 16 is in the upright position 18. The back rest 16 may extend outwardly from the seat 14 when the back rest 16 is in the reclined position 20. For example, the back rest 16 may be parallel to the seat 14 when the back rest 16 is in the reclined position 20.

The seat 14 generally includes a pair of seat rods 22 that are spaced from each other. The pair of seat rods 22 are generally parallel to each other. The pair of seat rods 22 are generally coplanar with each other. Each seat rod of the pair of seat rods 22 is extendable and retractable to adjust a length of each seat rod of the pair of seat rods 22.

Each seat rod of the pair of seat rods 22 may include a seat rod primary member 24. The seat rod primary member 24 may have a seat rod primary member forward end 26 that is spaced from the back rest 16. A seat rod secondary member 28 may be nested within the seat rod primary member 24 wherein the seat rod secondary member 28 is extendable and retractable relative to the seat rod primary member 24 to selectively adjust the length of the pair of seat rods 22.

A seat rod retainer 30 may be engageable with the seat rod primary member 24 and the seat rod secondary member 28 to releasably secure a position of the seat rod primary member 24 relative to the seat rod secondary member 28. For example, a seat rod primary member aperture 32 may extend through the seat rod primary member 24. The seat rod primary member aperture 32 is generally positioned adjacent to a junction between the seat rod primary member 24 and the seat rod secondary member 28. A plurality of seat rod secondary member apertures 34 may extend through the seat rod secondary member 28. The plurality of seat rod secondary member apertures 34 are generally aligned with each other. Each seat rod secondary member 28 aperture of the plurality of seat rod secondary member apertures 34 may be selectively alignable with the seat rod primary member aperture 32. A seat rod pin 36 may be removably positionable within the seat rod primary member aperture 32 and an aligned one of the plurality of seat rod secondary member apertures 34.

A seat rest 38 may be coupled to and extend between the pair of seat rods 22 wherein the seat rest 38 is configured to support 74 a body of a user 11 when the user 11 is sitting in the chair 12. The seat rest 38 may comprise a flexible material, such as fabric, wherein the seat rest 38 is configured to sag when the pair of seat rods 22 are fully retracted.

The back rest 16 may include a pair of back rest rods 40 that are spaced from each other. The pair of back rest rods 40 are generally parallel to each other. Each back rest rod of the pair of back rest rods 40 may be pivotably coupled to a respective seat rod of the pair of seat rods 22. The pair of back rest rods 40 may be perpendicular to the pair of seat rods 22 when the back rest 16 is in the upright position 18. The pair of back rest rods 40 may be parallel to the pair of seat rods 22 when the back rest 16 is in the reclined position 20. The pair of back rest rods 40 is generally coplanar with each other. Each back rest rod of the pair of back rest rods 40 may be extendable and retractable to selectively adjust a length of each back rest rod of the pair of back rest rods 40.

For example, a back rest rod primary member 42. The back rest rod primary member 42 may have a back rest rod primary member top end 44 that is spaced from the seat 14. A back rest rod secondary member 46 may be nested within the back rest rod primary member 42 wherein the back rest rod secondary member 46 is extendable and retractable relative to the back rest rod primary member 42 to selectively adjust the length of the pair of back rest rods 40. The back rest rod secondary member 46 may be pivotably coupled to the seat rod secondary member 28.

A back rest rod retainer 48 may be engageable with the back rest rod primary member 42 and the back rest rod secondary member 46 to releasably secure a position of the back rest rod primary member 42 relative to the back rest rod secondary member 46. For example, a back rest rod primary member aperture 50 may extend through the back rest rod primary member 42. The back rest rod primary member aperture 50 is generally positioned adjacent to a junction between the back rest rod primary member 42 and the back rest rod secondary member 46. In other words, the back rest rod primary member aperture 50 may be spaced from the back rest rod primary member top end 44.

A plurality of back rest rod secondary member apertures 52 may extend through the back rest rod secondary member 46. The plurality of back rest rod secondary member apertures 52 are generally aligned with each other. Each back rest rod secondary member 46 aperture of the plurality of back rest rod secondary member apertures 52 may be selectively alignable with the back rest rod primary member aperture 50. A back rest rod pin 54 may be removably positionable within the back rest rod primary member aperture 50 and an aligned one of the plurality of back rest rod secondary member apertures 52.

A back rest cross member 56 may be coupled to and extend between the pair of back rest rods 40. The back rest cross member 56 may be perpendicular to the pair of back rest rods 40, as shown in FIG. 1b. The back rest cross member 56 is generally coplanar with the pair of back rest rods 40. The back rest cross member 56 may be extendable and retractable to selectively adjust a distance between the pair of back rest rods 40.

For example, the back rest cross member 56 may include a back rest cross member primary shaft 58. A back rest cross member secondary shaft 60 may be nested within the back rest cross member primary shaft 58 wherein the back rest cross member secondary shaft 60 is extendable and retractable relative to the back rest cross member primary shaft 58 to selectively adjust the distance between the pair of back rest rods 40.

A back rest cross member retainer 62 may be engageable with the back rest cross member primary shaft 58 and the back rest cross member secondary shaft 60 to releasably secure a position of the back rest cross member primary shaft 58 relative to the back rest cross member secondary shaft 60. For example, a back rest cross member primary shaft aperture 64 may extend through the back rest cross member primary shaft 58. The back rest cross member primary shaft aperture 64 is generally positioned adjacent to a junction between the back rest cross member primary shaft 58 and the back rest cross member secondary shaft 60. For example, the back rest cross member primary shaft aperture 64 may be spaced from the pair of back rest rods 40. A plurality of back rest cross member secondary shaft apertures 66 may extend through the back rest cross member secondary shaft 60. The plurality of back rest cross member secondary shaft apertures 66 are generally aligned with each other. Each back rest cross member secondary shaft aperture of the plurality of back rest cross member secondary shaft apertures 66 may be selectively alignable with the back rest cross member primary shaft aperture 64. A back rest cross member pin 68 may be removably positionable within the back rest cross member primary shaft aperture 64 and an aligned one of the plurality of back rest cross member secondary shaft apertures 66.

A back rest mat 70 may be coupled to and extend between the pair of back rest rods 40. The back rest mat 70 is generally configured to support 74 the body of the user 11 when the user 11 is sitting in the chair 12. The back rest mat 70 may comprising a flexible material, such as fabric, wherein the back rest mat 70 is configured to sag when each of the pair of back rest rods 40 and the back rest cross member 56 are fully retracted.

A head rest mat 72 may be coupled to and extend between the pair of back rest rods 40. The head rest mat 72 is generally configured to support 74 a head of the user 11 when the user 11 is sitting in the chair 12. The head rest mat 72 may be spaced from the back rest mat 70. The head rest mat 72 may be positioned between the back rest mat 70 and the back rest rod primary member top end 44. The head rest mat 72 may comprise a flexible material, such as fabric, wherein the head rest mat 72 is configured to sag when each of the pair of back rest rods 40 and the back rest cross member 56 are fully retracted.

A support 74 may be coupled to the seat 14 of the chair 12. The support 74 is generally positioned beneath the seat 14 wherein the support 74 is configured to support 74 the chair 12 above a surface 76, such as the floor or the ground.

For example, a pair of forward support rods 78 may be perpendicular to the pair of seat rods 22. Each forward support rod of the pair of forward support rods 78 may be coupled to and extend downwardly from the seat rod primary member 24 of a respective seat rod of the pair of seat rods 22. For example, each forward support rod of the pair of forward support rods 78 may be positioned adjacent to the seat rod primary member forward end 26 of the seat rod primary member 24 of the respective seat rod of the pair of seat rods 22. Each forward support rod of the pair of forward support rods 78 may be perpendicular to the seat rod primary member 24 of the respective seat rod of the pair of seat rods 22.

A pair of back support rods 80 may be parallel to the pair of forward support rods 78. Each back support rod of the pair of back support rods 80 may be coupled to and extend downwardly from the back rest rod secondary member 46 of a respective back rest rod of the pair of back rest rods 40. The pair of back support rods 80 may be parallel to the pair of back rest rods 40 when the back rest 16 is in the upright position 18. The pair of back support rods 80 may be perpendicular to the pair of back rest rods 40 when the back rest 16 is in the reclined position 20.

Each back support rod of the pair of back support rods 80 may include a back support rod primary member 82. A back support rod secondary member 84 may be nested within the back support rod primary member 82 wherein the back support rod secondary member 84 is extendable and retractable relative to the back support rod primary member 82. The extension and retraction of each back support rod of the pair of back support rods 80 is generally configured to selectively adjust a distance between the chair 12 and the surface 76.

A back support rod retainer 86 may be engageable with the back support rod primary member 82 and the back support rod secondary member 84 to releasably secure a position of the back support rod primary member 82 relative to the back support rod secondary member 84. For example, a back support rod primary member aperture 88 may extend through the back support rod primary member 82. The back support rod primary member aperture 88 is generally positioned adjacent to a junction between the back support rod primary member 82 and the back support rod secondary member 84. A plurality of back support rod secondary member apertures 90 may extend through the back support rod secondary member 84. The plurality of back support rod secondary member apertures 90 are generally aligned with each other. Each back support rod secondary member aperture of the plurality of back support rod secondary member apertures 90 may be selectively alignable with the back support rod primary member aperture 88. A back support rod pin 92 may be removably positionable within the back support rod primary member aperture 88 and an aligned one of the plurality of back support rod secondary member apertures 90.

A pair of central support rods 94 may be parallel to the pair of forward support rods 78. The pair of central support rods 94 is generally spaced from the pair of forward support rods 78. Each central support rod of the pair of central support rods 94 may be coupled to and extend downwardly from the seat rod primary member 24 of the respective seat rod of the pair of seat rods 22. Each central support rod of the pair of central support rods 94 may have a length that is less than a length of the pair of back support rods 80.

Each central support rod of the pair of central support rods 94 may include a central support rod primary member 96. A central support rod secondary member 98 may be nested within the central support rod primary member 96 wherein the central support rod secondary member 98 is extendable and retractable relative to the central support rod primary member 96. Extension and retraction of the pair of central support rods 94 is generally configured to selectively adjust the distance between the chair 12 and the surface 76.

A central support rod retainer 100 may be engageable with the central support rod primary member 96 and the central support rod secondary member 98 to releasably secure a position of the central support rod primary member 96 relative to the central support rod secondary member 98. For example, a central support rod primary member aperture 102 may extend through the central support rod primary member 96. The central support rod primary member aperture 102 may be positioned adjacent to a junction between the central support rod primary member 96 and the central support rod secondary member 98. A plurality of central support rod secondary member apertures 104 may extend through the central support rod secondary member 98. The plurality of central support rod secondary member apertures 104 are generally aligned with each other. Each central support rod secondary member aperture of the plurality of central support rod secondary member apertures 104 may be selectively alignable with the central support rod primary member aperture 102. A central support rod pin 106 may be removably positionable within the central support rod primary member aperture 102 and an aligned one of the plurality of central support rod secondary member apertures 104.

The support 74 may further include a pair of arcuate rods 108. Each arcuate rod of the pair of arcuate rods 108 may be coupled to and extend between a respective forward support rod of the pair of forward support rods 78 and a respective central support rod of the pair of central support rods 94.

Each arcuate rod of the pair of arcuate rods 108 may include a fixed end 110 that is coupled to the central support rod primary member 96 of the respective central support rod of the pair of central support rods 94. An upper surface 112 of each arcuate rod of the pair of arcuate rods 108 may be convexly arcuate between the respective forward support rod of the pair of forward support rods 78 and the respective central support rod of the pair of central support rods 94. A lower surface 114 of each arcuate rod of the pair of arcuate rods 108 mat be concavely arcuate between the respective forward support rod of the pair of forward support rods 78 and the respective central support rod of the pair of central support rods 94. A sleeve 116 may be movably coupled to the respective forward support rod of the pair of forward support rods 78. The sleeve 116 may be configured to slide along the respective forward support rod of the pair of forward support rods 78 when the distance between the chair 12 and the surface 76 is adjusted.

A pair of support cross members 118 may be parallel to the pair of seat rods 22. Each cross member of the pair of support cross members 118 may be coupled to and extend between a respective back support rod of the pair of back support rods 80 and a respective central support rod of the pair of central support rods 94.

For example, each support cross member of the pair of support cross members 118 may include a support cross member primary shaft 120 that is coupled to the central support rod primary member 96 of the respective central support rod of the pair of central support rods 94. A support cross member secondary shaft 122 may be nested within the support cross member primary shaft 120 wherein the support cross member secondary shaft 122 is extendable and retractable relative to the support cross member primary shaft 120 to selectively adjust the length of the pair of seat rods 22. The support cross member secondary shaft 122 may be coupled to the back support rod primary member 82 of the respective back support rod of the pair of back support rods 80.

A support cross member retainer 124 may be engageable with the support cross member primary shaft 120 and the support cross member secondary shaft 122 to releasably secure a position of the support cross member primary shaft 120 relative to the support cross member secondary shaft 122. For example, a support cross member primary shaft aperture 126 may extend through the support cross member primary shaft 120. The support cross member primary shaft aperture 126 may be positioned adjacent to a junction between the support cross member primary shaft 120 and the support cross member secondary shaft 122. A plurality of support cross member secondary shaft apertures 128 may extend through the support cross member secondary shaft 122. The plurality of support cross member secondary shaft apertures 128 are generally aligned with each other. Each support cross member secondary shaft 122 aperture of the plurality of support cross member secondary shaft apertures 128 may be selectively alignable with the support cross member primary shaft aperture 126. A support cross member pin 130 may be removably positionable within the support cross member primary shaft aperture 126 and an aligned one of the plurality of support cross member secondary shaft apertures 128.

A pair of drive wheels 132 may be coupled to the support 74. The pair of drive wheels 132 may be positioned proximate to a junction between the seat 14 and the back rest 16. For example, the back rest 16 may be positioned between the pair of drive wheels 132 when the back rest 16 is in the reclined position 20. Each drive wheel of the pair of drive wheels 132 may be rotatably coupled to the back support rod primary member 82 of a respective back support rod of the pair of back support rods 80.

A pair of front wheels 134 may be coupled to the support 74. The pair of front wheels 134 is generally spaced from the pair of drive wheels 132. The pair of front wheels 134 may have a diameter that is less than a diameter of the pair of drive wheels 132. Each front wheel of the pair of front wheels 134 may be rotatably coupled to a respective forward support rod of the pair of forward support rods 78.

A pair of rear wheels 136 may be coupled to the support 74. The pair of drive wheels 132 is generally positioned between the pair of rear wheels 136 and the pair of front wheels 134. The pair of rear wheels 136 may have a diameter that is less than a diameter of the pair of front wheels 134. Each rear wheel of the pair of rear wheels 136 may be rotatably coupled to the back support rod primary member 82 of the respective back support rod of the pair of back support rods 80.

A rear wheel support frame 138 may couple each rear wheel of the pair of rear wheels 136 to the respective back support rod of the pair of back support rods 80. For example, a rear wheel first support rod 140 may be perpendicular to the back support rod primary member 82 of the respective back support rod of the pair of back support rods 80. The rear wheel first support rod 140 may include a rear wheel first support rod primary member 142. A rear wheel first support rod secondary member 144 may be nested within the rear wheel first support rod primary member 142. The rear wheel first support rod secondary member 144 may be extendable and retractable relative to the rear wheel first support rod primary member 142 to selectively adjust a length of the rear wheel first support rod 140.

A rear wheel first support rod retainer 146 may be engageable with the rear wheel first support rod primary member 142 and the rear wheel first support rod secondary member 144 to releasably secure a position of the rear wheel first support rod secondary member 144 relative to the rear wheel first support rod primary member 142. For example, a rear wheel first support rod primary member aperture 148 may extend through the rear wheel first support rod primary member 142. The rear wheel first support rod primary member aperture 148 may be positioned adjacent to a junction between the rear wheel first support rod primary member 142 and the rear wheel first support rod secondary member 144. A plurality of rear wheel first support rod secondary member apertures 150 may extend through the rear wheel first support rod secondary member 144. The plurality of rear wheel first support rod secondary member apertures 150 are generally aligned with each other. Each rear wheel first support rod secondary member aperture of the plurality of first rear wheel support 74 rod may be selectively alignable with the rear wheel first support rod primary member aperture 148. A rear wheel first support rod pin 152 may be removably positionable within the rear wheel first support rod primary member aperture 148 and an aligned one of the plurality of rear wheel first support rod secondary member apertures 150.

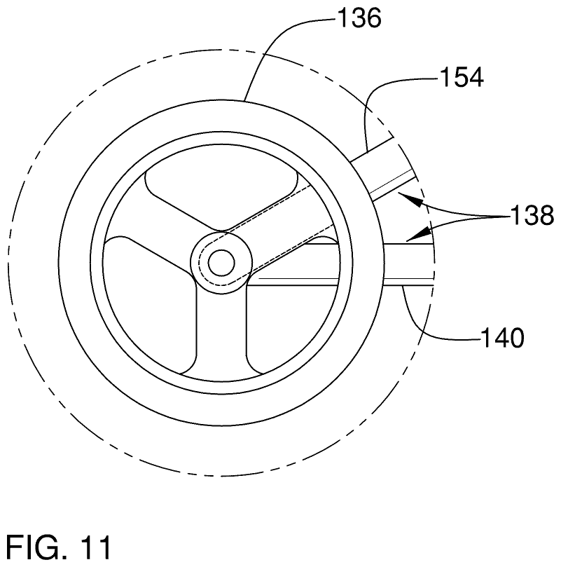

A rear wheel second support rod 154 may be angled relative to the back support rod primary member 82 of the respective back support rod of the pair of back support rods 80. Specifically, the rear wheel second support rod 154 may extend outwardly from the respective back support rod of the pair of pack support rods 80, and downwardly toward the rear wheel first support rod 140. The rear wheel second support rod 154 may be pivotably coupled to the respective back support rod of the pair of pack support rods 80 and may also be pivotably coupled to a respective rear wheel of the pair of rear wheels 136, for example as shown in FIG. 11. The rear wheel second support rod 154 is pivotable to facilitate extension and retraction of the rear wheel second support rod 154 relative to the rear wheel first support rod 140. The pivotable movement of the rear wheel second support rod 154 is configured to facilitate the user 11 in adjusting a position of the pair of rear wheels 136 relative to the back support rod primary member 82, to adjust a center of gravity of the chair 12 when the back rest 16 is in the reclined position 20.

For example, the rear wheel second support rod 154 may include a rear wheel second support rod primary member 156. A rear wheel second support rod secondary member 158 may be nested within the rear wheel second support rod primary member 156 wherein the rear wheel second support rod secondary member 158 is extendable and retractable relative to the rear wheel second support rod primary member 156 to selectively adjust a length of the rear wheel second support rod 154.

A rear wheel second support rod retainer 160 may be engageable with the rear wheel second support rod primary member 156 and the rear wheel second support rod secondary member 158 to releasably secure a position of the rear wheel second support rod secondary member 158 relative to the rear wheel second support rod primary member 156. For example, a rear wheel second support rod primary member aperture 162 may extend through the rear wheel second support rod primary member 156. The rear wheel second support rod primary member aperture 162 is generally positioned adjacent to a junction between the rear wheel second support rod primary member 156 and the rear wheel second support rod secondary member 158. A plurality of rear wheel second support rod secondary member apertures 164 may extend through the rear wheel second support rod secondary member 158. The plurality of rear wheel second support rod secondary member apertures 164 are generally aligned with each other. Each rear wheel second support rod secondary member aperture of the plurality of rear wheel second support rod secondary member apertures 164 may be selectively alignable with the rear wheel second support rod primary member aperture 162. A rear wheel second support rod pin 166 may be removably positionable within the rear wheel second support rod primary member aperture 162 and an aligned one of the plurality of rear wheel second support rod secondary member apertures 164.

A pair of arm rests 168 may be coupled to the seat 14. The pair of arm rests 168 generally extend upwardly from opposing lateral sides of the seat 14 wherein the pair of arm rests 168 are configured to support a pair of arms of the user 11 when the user 11 is sitting on the chair 12.

Each arm rest of the pair of arm rests 168 may include a pair of arm rest lateral rods 170. Each arm rest lateral rod of the pair of arm rest lateral rods 170 may be coupled to a respective seat rod of the pair of seat rods 22. Each arm rest lateral rod of the pair of arm rest lateral rods 170 may extend upwardly from the respective seat rod of the pair of seat rods 22. For example, the pair of arm rest lateral rods 170 may be perpendicular to the respective seat rod of the pair of seat rods 22.

Each arm rest lateral rod of the pair of arm rest lateral rods 170 may include an arm rest lateral rod primary member 172 that is positioned on the seat rod primary member 24 of the respective seat rod of the pair of seat rods 22. An arm rest lateral rod secondary member 174 may be nested within the arm rest lateral rod primary member 172 wherein the arm rest lateral rod secondary member 174 is extendable and retractable relative to the arm rest lateral rod primary member 172 to selectively adjust a height of each arm rest of the pair of arm rests 168. The arm rest lateral rod secondary member 174 may be positioned on the seat rod secondary member 28 of the respective seat rod of the pair of seat rods 22. The arm rest lateral rod secondary member 174 is generally spaced from the arm rest lateral rod primary member 172.

An arm rest lateral rod retainer 176 may be engageable with the arm rest lateral rod primary member 172 and the arm rest lateral rod secondary member 174 to releasably secure a position of the arm rest lateral rod secondary member 174 relative to the arm rest lateral rod primary member 172. For example, an arm rest lateral rod primary member aperture 178 may extend through the arm rest lateral rod primary member 172. The arm rest lateral rod primary member aperture 178 is generally positioned adjacent to a junction between the arm rest lateral rod primary member 172 and the arm rest lateral rod secondary member 174. A plurality of arm rest lateral rod secondary member apertures 180 may extend through the arm rest lateral rod secondary member 174. The plurality of arm rest lateral rod secondary member apertures 180 are generally aligned with each other. Each arm rest lateral rod secondary member aperture of the plurality of arm rest lateral rod secondary member apertures 180 may be selectively alignable with the arm rest lateral rod primary member aperture 178. An arm rest lateral rod pin 182 may be removably positionable within the arm rest lateral rod primary member aperture 178 and an aligned one of the plurality of arm rest lateral rod secondary member apertures 180.

An arm rest upper rod 184 may be coupled to and extend between the pair of arm rest lateral rods 170. The arm rest upper rod 184 is generally parallel to the respective seat rod of the pair of seat rods 22. The arm rest upper rod 184 may include an arm rest upper rod primary member 186. An arm rest upper rod secondary member 188 may be nested within the arm rest upper rod primary member 186 wherein the arm rest upper rod secondary member 188 is extendable and retractable relative to the arm rest upper rod primary member 186 to selectively adjust a length of each arm rest of the pair of arm rests 168.

An arm rest upper rod retainer 190 may be engageable with the arm rest upper rod primary member 186 and the arm rest upper rod secondary member 188 to releasably secure a position of the arm rest upper rod secondary member 188 relative to the arm rest upper rod primary member 186. For example, an arm rest upper rod primary member aperture 192 may extend through the arm rest upper rod primary member 186. The arm rest upper rod primary member aperture 192 is generally positioned proximate to a junction between the arm rest upper rod primary member 186 and the arm rest upper rod secondary member 188. A plurality of arm rest upper rod secondary member apertures 194 may extend through the arm rest upper rod secondary member 188. The plurality of arm rest upper rod secondary member apertures 194 are generally aligned with each other. Each arm rest upper rod secondary member aperture of the plurality of arm rest upper rod secondary member apertures 194 may be alignable with the arm rest upper rod primary member aperture 192. An arm rest upper rod pin 196 may be removably positionable within the arm rest upper rod primary member aperture 192 and an aligned one of the plurality of arm rest upper rod secondary member apertures 194.

An arm rest pad 198 may be coupled to the arm rest upper rod 184. The arm rest pad 198 may have a width exceeding a width of the arm rest upper rod 184 wherein the arm rest pad 198 extends outwardly past opposing lateral edges of the arm rest upper rod 184.

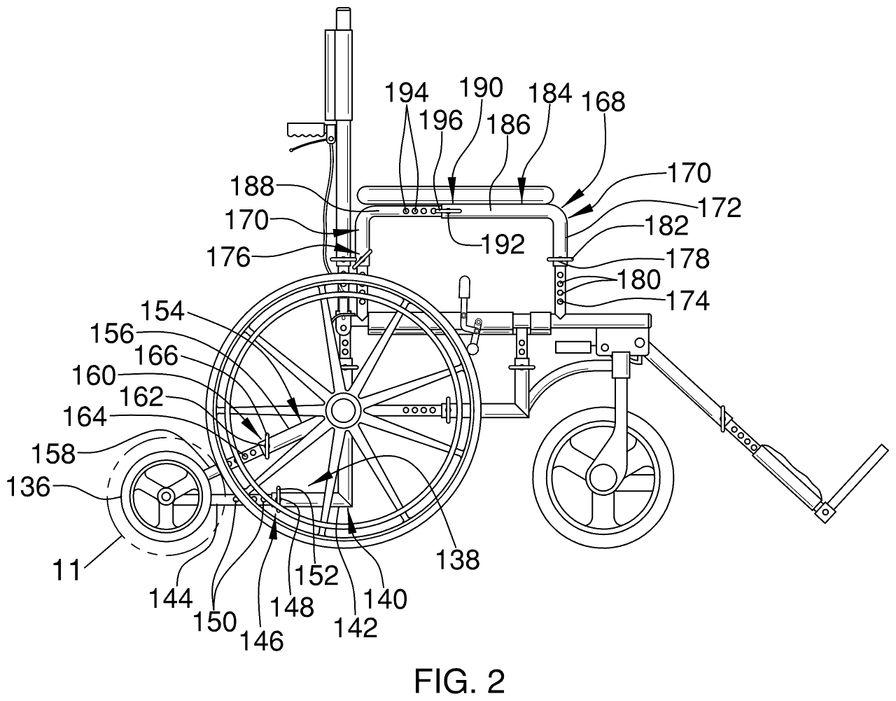

A pair of foot rests 200 may be coupled to and extend from the seat 14 of the chair 12. The pair of foot rests 200 may be angled wherein the pair of foot rests 200 extend forwardly and downwardly from the seat 14. The pair of foot rests 200 are configured to support 74 a pair of legs and a pair of feet of the user 11 when the user 11 is sitting in the chair 12. The pair of foot rests 200 may be pivotably coupled to the chair 12 wherein the pair of foot rests 200 are pivotable upwards and downwards to facilitate comfort of the user 11 when the user 11 is sitting in the chair 12. For example, the pair of foot rests 200 may be pivoted upwardly while the back rest 16 is in the reclined position to facilitate the user 11 in laying down in the chair 12, as shown in FIG. 3. The pair of foot rests 200 may also be removably coupled to the chair 12 wherein the pair of foot rests 200 are detachable from the chair 12 to facilitate storage of the chair 12.

Each foot rest of the pair of foot rests 200 may include a foot rest primary rod 202 that is positioned proximate to the seat rod primary member forward end 26 of the seat rod primary member 24 of a respective seat rod of the pair of seat rods 22. In some embodiments, the foot rest primary rod 202 may be pivotably coupled to a respective forward support rod of the pair of forward support rods 78 of the support 74 wherein the foot rest primary rod 202 is pivotable upwards and downwards to adjust an angle of each foot rest of the pair of foot rests 200 relative to the seat 14 of the chair 12.

A foot rest secondary rod 204 may be coupled to the foot rest primary rod 202. The foot rest secondary rod 204 may be nested within the foot rest primary rod 202 wherein the foot rest secondary rod 204 is extendable and retractable relative to the foot rest primary rod 202 to selectively adjust a length of each foot rest of the pair of foot rests 200. A foot rest plate 206 may be coupled to the foot rest secondary rod 204. The foot rest plate 206 may extend outwardly from the foot rest secondary rod 204 wherein the foot rest plate 206 is configured to support a respective foot of the pair of feet of the user 11 when the user 11 is sitting in the chair 12.

A foot rest retainer 208 may be engageable with the foot rest primary rod 202 and the foot rest secondary rod 204 to releasably secure a position of the foot rest primary rod 202 relative to the foot rest secondary rod 204. For example, a foot rest primary rod aperture 210 may extend through the foot rest primary rod 202. The foot rest primary rod aperture 210 is generally positioned adjacent to a junction between the foot rest primary rod 202 and the foot rest secondary rod 204. A plurality of foot rest secondary rod apertures 212 may extend through the foot rest secondary rod 204. The plurality of foot rest secondary rod apertures 212 are generally aligned with each other. Each foot rest secondary rod aperture of the plurality of foot rest secondary rod apertures 212 may be alignable with the foot rest primary rod aperture 210. A foot rest rod pin 214 may be removably positionable within the foot rest primary rod aperture 210 and an aligned one of the plurality of foot rest secondary rod apertures 212.

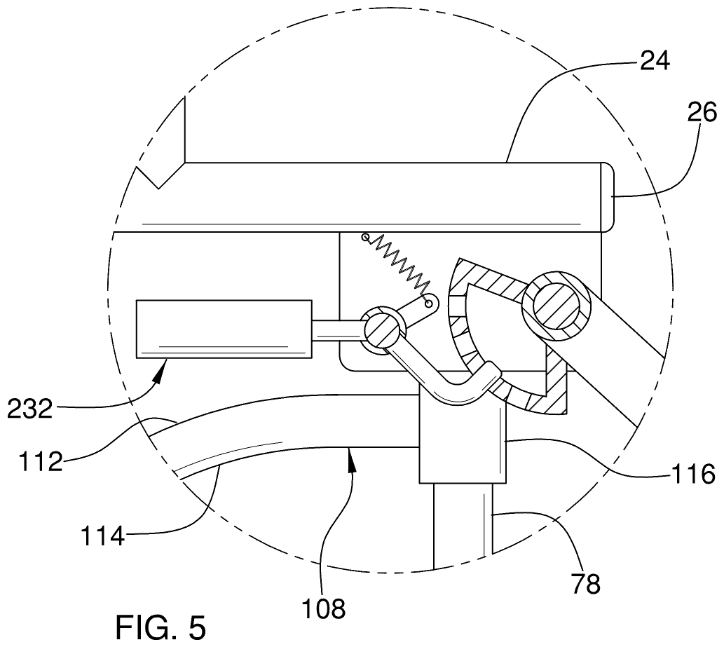

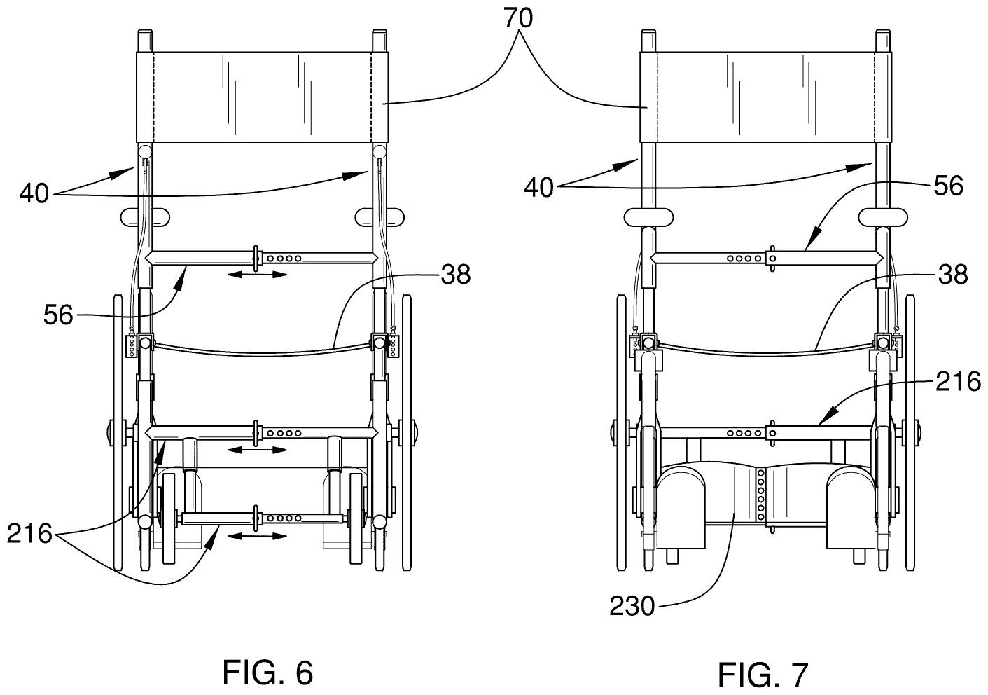

A foot rest cross member 216 may be coupled to and extend between the pair of foot rests 200. The foot rest cross member 216 may be perpendicular to the pair of foot rests 200. The foot rest cross member 216 may be extendable and retractable to adjust a distance between the pair of foot rests 200. Alternative embodiments, such as those shown in FIGS. 6 and 7, may include a pair of foot rest cross members 216 that are vertically spaced from each other.

For example, the foot rest cross member 216 may include a foot rest cross member primary shaft 218. A foot rest cross member secondary shaft 220 may be nested within the foot rest cross member primary shaft 218 wherein the foot rest cross member secondary shaft 220 is extendable and retractable relative to the foot rest cross member primary shaft 218 to selectively adjust the distance between the pair of foot rests 200.

A foot rest cross member retainer 222 may be engageable with the foot rest cross member primary shaft 218 and the foot rest cross member secondary shaft 220 to releasably secure a position of the foot rest cross member secondary shaft 220 relative to the foot rest cross member primary shaft 218. For example, a foot rest cross member primary shaft aperture 224 may extend through the foot rest cross member primary shaft 218. The foot rest cross member primary shaft aperture 224 is generally positioned proximate to a junction between the foot rest cross member primary shaft 218 and the foot rest cross member secondary shaft 220. A plurality of foot rest cross member secondary shaft apertures 226 may extend through the foot rest cross member secondary shaft 220. The plurality of foot rest cross member secondary shaft apertures 226 are generally aligned with each other. Each foot rest cross member secondary shaft 220 aperture of the plurality of foot rest cross member secondary shaft apertures 226 may be alignable with the foot rest cross member primary shaft aperture 224. A foot rest cross member pin 228 may be removably positionable within the foot rest cross member primary shaft aperture 224 and an aligned one of the plurality of foot rest cross member secondary shaft apertures 226.

A calf pad 230 may be coupled to and extend between the pair of foot rests 200. For example, the calf pad 230 may be positioned on the foot rest secondary rod 204 proximate to the foot rest plate 206 of each foot rest of the pair of foot rests 200. The calf pad 230 is generally configured to be alignable with a pair of calves of the user 11 when the user 11 is sitting in the chair 12. For example, the user 11 may rest the calves of the pair of legs on the calf pad 230.

In use, the dimensions of the seat 14, the back rest 16, the pair of arm rests 168, and the pair of foot rests 200 can be adjusted based on the size, comfort, and preferences of the user 11. For example, the pair of seat rods 22 and the pair of back rest rods 40 may be extended to accommodate a user 11 who is tall. Similarly, the back rest cross member 56 and the foot rest cross member 216 may be extended to accommodate a user 11 who is wide. In another example, the pair of back support rods 80 and the pair of central support rods 94 may be retracted to accommodate a user 11 who is short.

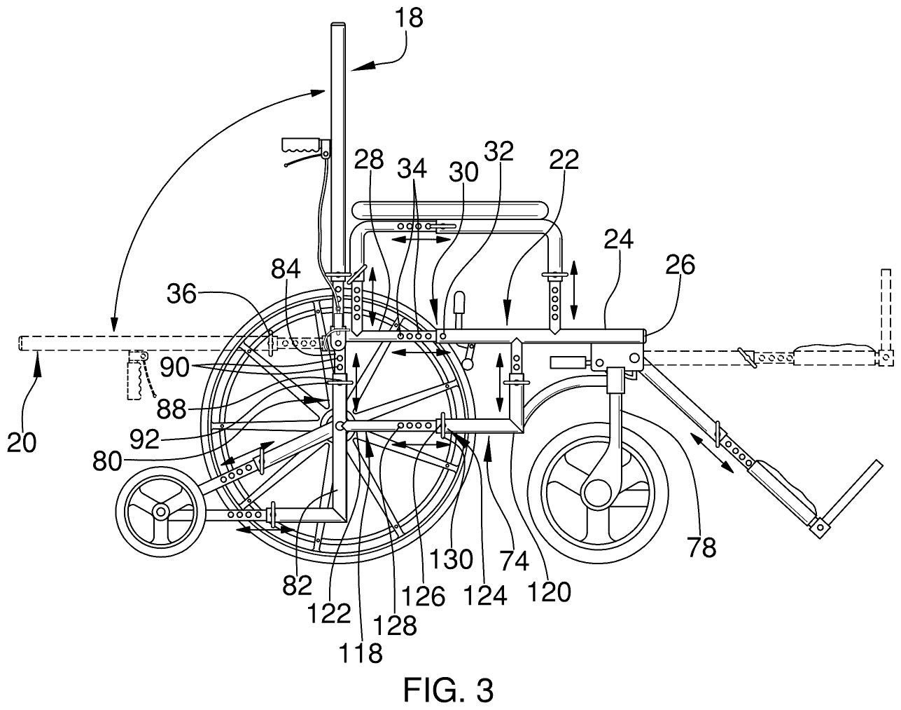

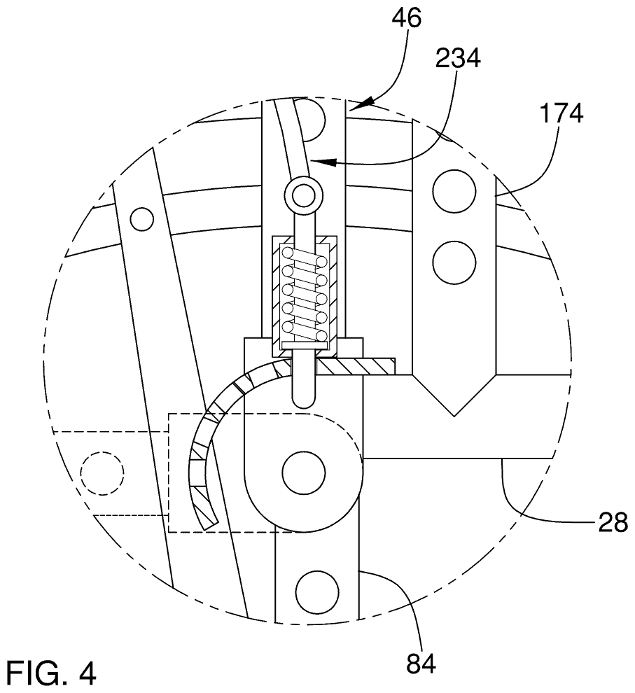

The rear wheel support frame 138 may be extended to increase a distance between the pair of rear wheels 136 and the pair of drive wheels 132. For example, extending the rear wheel support frame 138 may add stability to the expandable wheelchair 12 device when the back rest 16 is in the reclined position 20, particularly when the pair of foot rests 200 are angled upwards. The back rest release lever 234 shown in FIG. 4 can be used to pivot the back rest 16 between the back rest 16 between the upright position 18 and the reclined position 20. The angle of the pair of foot rests 200 can be adjusted using the foot rest release lever 232 shown in FIG. 5.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

I claim:

1. A wheelchair assembly comprising:
a chair having a seat and a back rest;
the seat including:
a pair of seat rods being spaced from each other, each seat rod of the pair of seat rods being extendable and retractable to adjust a length of the pair of seat rods;
the back rest including:
a pair of back rest rods being spaced from each other, each back rest rod of the pair of back rest rods being extendable and retractable to adjust a length of the pair of back rest rods;
a support being coupled to the seat of the chair, the support being positioned beneath the seat wherein the support is configured to support the chair above a surface;
a pair of drive wheels being rotatably coupled to the support, the pair of drive wheels being positioned proximate to a junction between the seat and the back rest; and
a pair of front wheels being rotatably coupled to the support, the pair of front wheels being spaced from the pair of drive wheels.

2. The wheelchair assembly of claim 1, each seat rod of the pair of seat rods further comprising:
a seat rod primary member; and
a seat rod secondary member being nested within the seat rod primary member wherein the seat rod secondary member is extendable and retractable relative to the seat rod primary member to adjust the length of the pair of seat rods.

3. The wheelchair assembly of claim 2, each seat rod of the pair of seat rods further comprising a seat rod retainer being engageable with the seat rod primary member and the seat rod secondary member to releasably secure a position of the seat rod primary member relative to the seat rod secondary member.

4. The wheelchair assembly of claim 1, further comprising:
a seat rest being coupled to and extending between the pair of seat rods wherein the seat rest is configured to support a body of a user when the user is sitting in the chair; and
a back rest mat being coupled to and extending between the pair of back rest rods wherein the back rest mat is configured to support the body of the user when the user is sitting in the chair.

5. The wheelchair assembly of claim 4, further comprising a head rest mat being coupled to and extending between the pair of back rest rods wherein the head rest mat is configured to support a head of the user when the user is sitting in the chair.

6. The wheelchair assembly of claim 1, wherein the back rest is pivotably coupled to the seat wherein the back rest is pivotable between an upright position and a reclined position, the back rest extending upwardly from the seat when the back rest is in the upright position, the back rest extending outwardly from the seat when the back rest is in the reclined position.

7. The wheelchair assembly of claim 1, each back rest rod of the pair of back rest rods further comprising:
a back rest rod primary member; and
a back rest rod secondary member being nested within the back rest rod primary member wherein the back rest rod secondary member is extendable and retractable relative to the back rest rod primary member to adjust the length of the pair of back rest rods.

8. The wheelchair assembly of claim 7, each back rest rod of the pair of back rest rods further comprising a back rest rod retainer being engageable with the back rest rod primary member and the back rest rod secondary member to releasably secure a position of the back rest rod primary member relative to the back rest rod secondary member.

9. The wheelchair assembly of claim 1, the back rest further comprising a back rest cross member being coupled to and extending between the pair of back rest rods, the back rest cross member being extendable and retractable to adjust a distance between the pair of back rest rods
10. The wheelchair assembly of claim 9, the back rest cross member further comprising:
a back rest cross member primary shaft; and
a back rest cross member secondary shaft being nested within the back rest cross member primary shaft wherein the back rest cross member secondary shaft is extendable and retractable relative to the back rest cross member primary shaft to adjust the distance between the pair of back rest rods.

11. The wheelchair assembly of claim 10, the back rest cross member further comprising: a back rest cross member retainer being engageable with the back rest cross member primary shaft and the back rest cross member secondary shaft to releasably secure a position of the back rest cross member primary shaft relative to the back rest cross member secondary shaft.

12. The wheelchair assembly of claim 1, further comprising a pair of rear wheels being coupled to the support, the pair of drive wheels being positioned between the pair of rear wheels and the pair of front wheels.

13. The wheelchair assembly of claim 12, further comprising a rear wheel support frame coupling each rear wheel of the pair of rear wheels to the support.

14. The wheelchair assembly of claim 1, further comprising a pair of foot rests being coupled to and extending from the seat of the chair, the pair of foot rests being angled wherein the pair of foot rests extend forwardly and downwardly from the seat and wherein the pair of foot rests are configured to support a pair of feet of a user when the user is sitting in the chair.

15. The wheelchair assembly of claim 14, further comprising a foot rest cross member being coupled to and extending between the pair of foot rests, the foot rest cross member being extendable and retractable to adjust a distance between the pair of foot rests.

16. A wheelchair assembly comprising:
a chair having a seat and a back rest, the back rest being coupled to the seat, the back rest being pivotably coupled to the seat wherein the back rest is pivotable between an upright position and a reclined position, the back rest extending upwardly from the seat when the back rest is in the upright position, the back rest being perpendicular to the seat when the back rest is in the upright position, the back rest extending outwardly from the seat when the back rest is in the reclined position, the back rest being parallel to the seat when the back rest is in the reclined position;
the seat including:
a pair of seat rods being spaced from each other, the pair of seat rods being parallel to each other, the pair of seat rods being coplanar with each other, each seat rod of the pair of seat rods being extendable and retractable to adjust a length of each seat rod of the pair of seat rods, each seat rod of the pair of seat rods including:
a seat rod primary member having a seat rod primary member forward end being spaced from the back rest;
a seat rod secondary member being nested within the seat rod primary member wherein the seat rod secondary member is extendable and retractable relative to the seat rod primary member to adjust the length of the pair of seat rods; and
a seat rod retainer being engageable with the seat rod primary member and the seat rod secondary member to releasably secure a position of the seat rod primary member relative to the seat rod secondary member, the seat rod retainer including:
a seat rod primary member aperture extending through the seat rod primary member, the seat rod primary member aperture being positioned adjacent to a junction between the seat rod primary member and the seat rod secondary member;
a plurality of seat rod secondary member apertures extending through the seat rod secondary member, the plurality of seat rod secondary member apertures being aligned with each other, each seat rod secondary member aperture of the plurality of seat rod secondary member apertures being selectively alignable with the seat rod primary member aperture; and
a seat rod pin being removably positionable within the seat rod primary member aperture and an aligned one of the plurality of seat rod secondary member apertures; and
a seat rest being coupled to and extending between the pair of seat rods wherein the seat rest is configured to support a body of a user when the user is sitting in the chair;
the back rest including:
a pair of back rest rods being spaced from each other, the pair of back rest rods being parallel to each other, the pair of back rest rods being perpendicular to the pair of seat rods when the back rest is in the upright position, the pair of back rest rods being parallel to the pair of seat rods when the back rest is in the reclined position, the pair of back rest rods being coplanar with each other, each back rest rod of the pair of back rest rods being extendable and retractable to adjust a length of each back rest rod of the pair of back rest rods, each back rest rod of the pair of back rest rods including:
a back rest rod primary member having a back rest rod primary member top end being spaced from the seat;
a back rest rod secondary member being nested within the back rest rod primary member wherein the back rest rod secondary member is extendable and retractable relative to the back rest rod primary member to adjust the length of the pair of back rest rods, the back rest rod secondary member being pivotably coupled to the seat rod secondary member; and
a back rest rod retainer being engageable with the back rest rod primary member and the back rest rod secondary member to releasably secure a position of the back rest rod primary member relative to the back rest rod secondary member, the back rest rod retainer including:
a back rest rod primary member aperture extending through the back rest rod primary member, the back rest rod primary member aperture being positioned adjacent to a junction between the back rest rod primary member and the back rest rod secondary member wherein the back rest rod primary member aperture is spaced from the back rest rod primary member top end;
a plurality of back rest rod secondary member apertures extending through the back rest rod secondary member, the plurality of back rest rod secondary member apertures being aligned with each other, each back rest rod secondary member aperture of the plurality of back rest rod secondary member apertures being selectively alignable with the back rest rod primary member aperture; and
a back rest rod pin being removably positionable within the back rest rod primary member aperture and an aligned one of the plurality of back rest rod secondary member apertures;
a back rest cross member being coupled to and extending between the pair of back rest rods, the back rest cross member being perpendicular to the pair of back rest rods, the back rest cross member being coplanar with the pair of back rest rods, the back rest cross member being extendable and retractable to adjust a distance between the pair of back rest rods, the back rest cross member including:
a back rest cross member primary shaft;
a back rest cross member secondary shaft being nested within the back rest cross member primary shaft wherein the back rest cross member secondary shaft is extendable and retractable relative to the back rest cross member primary shaft to adjust the distance between the pair of back rest rods; and
a back rest cross member retainer being engageable with the back rest cross member primary shaft and the back rest cross member secondary shaft to releasably secure a position of the back rest cross member primary shaft relative to the back rest cross member secondary shaft, the back rest cross member retainer including:
a back rest cross member primary shaft aperture extending through the back rest cross member primary shaft, the back rest cross member primary shaft aperture being positioned adjacent to a junction between the back rest cross member primary shaft and the back rest cross member secondary shaft wherein the back rest cross member primary shaft aperture is spaced from the pair of back rest rods;
a plurality of back rest cross member secondary shaft apertures extending through the back rest cross member secondary shaft, the plurality of back rest cross member secondary shaft apertures being aligned with each other, each back rest cross member secondary shaft aperture of the plurality of back rest cross member secondary shaft apertures being selectively alignable with the back rest cross member primary shaft aperture; and
a back rest cross member pin being removably positionable within the back rest cross member primary shaft aperture and an aligned one of the plurality of back rest cross member secondary shaft apertures;
a back rest mat being coupled to and extending between the pair of back rest rods wherein the back rest mat is configured to support the body of the user when the user is sitting in the chair; and
a head rest mat being coupled to and extending between the pair of back rest rods wherein the head rest mat is configured to support a head of the user when the user is sitting in the chair, the head rest mat being spaced from the back rest mat, the head rest mat being positioned between the back rest mat and the back rest rod primary member top end;
a support being coupled to the seat of the chair, the support being positioned beneath the seat wherein the support is configured to support the chair above a surface, the support including:
a pair of forward support rods being perpendicular to the pair of seat rods, each forward support rod of the pair of forward support rods being coupled to and extending downwardly from the seat rod primary member of a respective seat rod of the pair of seat rods, each forward support rod of the pair of forward support rods being positioned adjacent to the seat rod primary member forward end of the seat rod primary member of the respective seat rod of the pair of seat rods, each forward support rod of the pair of forward support rods being perpendicular to the seat rod primary member of the respective seat rod of the pair of seat rods;
a pair of back support rods being parallel to the pair of forward support rods, each back support rod of the pair of back support rods being coupled to and extending downwardly from the back rest rod secondary member of a respective back rest rod of the pair of back rest rods, the pair of back support rods being parallel to the pair of back rest rods when the back rest is in the upright position, the pair of back support rods being perpendicular to the pair of back rest rods when the back rest is in the reclined position, each back support rod of the pair of back support rods including:
a back support rod primary member;
a back support rod secondary member being nested within the back support rod primary member wherein the back support rod secondary member is extendable and retractable relative to the back support rod primary member wherein the pair of back support rods is configured to adjust a distance between the chair and the surface; and
a back support rod retainer being engageable with the back support rod primary member and the back support rod secondary member to releasably secure a position of the back support rod primary member relative to the back support rod secondary member, the back support rod retainer including:
a back support rod primary member aperture extending through the back support rod primary member, the back support rod primary member aperture being positioned adjacent to a junction between the back support rod primary member and the back support rod secondary member;
a plurality of back support rod secondary member apertures extending through the back support rod secondary member, the plurality of back support rod secondary member apertures being aligned with each other, each back support rod secondary member aperture of the plurality of back support rod secondary member apertures being selectively alignable with the back support rod primary member aperture; and
a back support rod pin being removably positionable within the back support rod primary member aperture and an aligned one of the plurality of back support rod secondary member apertures;
a pair of drive wheels being coupled to the support, the pair of drive wheels being positioned proximate to a junction between the seat and the back rest wherein the back rest is positioned between the pair of drive wheels when the back rest is in the reclined position, each drive wheel of the pair of drive wheels being rotatably coupled to the back support rod primary member of a respective back support rod of the pair of back support rods;
a pair of front wheels being coupled to the support, the pair of front wheels being spaced from the pair of drive wheels, the pair of front wheels having a diameter being less than a diameter of the pair of drive wheels, each front wheel of the pair of front wheels being rotatably coupled to a respective forward support rod of the pair of forward support rods;
a pair of rear wheels being coupled to the support, the pair of drive wheels being positioned between the pair of rear wheels and the pair of front wheels, the pair of rear wheels having a diameter being less than a diameter of the pair of front wheels, each rear wheel of the pair of rear wheels being rotatably coupled to the back support rod primary member of the respective back support rod of the pair of back support rods;
a rear wheel support frame coupling each rear wheel of the pair of rear wheels to the respective back support rod of the pair of back support rods, the rear wheel support frame including:
a rear wheel first support rod being perpendicular to the back support rod primary member of the respective back support rod of the pair of back support rods, the rear wheel first support rod including:
a rear wheel first support rod primary member;
a rear wheel first support rod secondary member being nested within the rear wheel first support rod primary member wherein the rear wheel first support rod secondary member is extendable and retractable relative to the rear wheel first support rod primary member to adjust a length of the rear wheel first support rod; and
a rear wheel first support rod retainer being engageable with the rear wheel first support rod primary member and the rear wheel first support rod secondary member to releasably secure a position of the rear wheel first support rod secondary member relative to the rear wheel first support rod primary member, the rear wheel first support rod retainer including:
a rear wheel first support rod primary member aperture extending through the rear wheel first support rod primary member, the rear wheel first support rod primary member aperture being positioned adjacent to a junction between the rear wheel first support rod primary member and the rear wheel first support rod secondary member;
a plurality of rear wheel first support rod secondary member apertures extending through the rear wheel first support rod secondary member, the plurality of rear wheel first support rod secondary member apertures being aligned with each other, each rear wheel first support rod secondary member aperture of the plurality of first rear wheel support rod being alignable with the rear wheel first support rod primary member aperture; and
a rear wheel first support rod pin being removably positionable within the rear wheel first support rod primary member aperture and an aligned one of the plurality of rear wheel first support rod secondary member apertures;
a rear wheel second support rod being angled relative to the back support rod primary member of the respective back support rod of the pair of back support rods wherein the rear wheel second support rod extends outwardly from the respective back support rod and downwardly toward the rear wheel first support rod, the rear wheel second support rod being pivotably coupled to a respective rear wheel of the pair of rear wheels wherein the rear wheel second support rod is pivotable to facilitate extension and retraction of the rear wheel support frame wherein the rear wheel second support rod is configured to facilitate the user in adjusting a position of the pair of rear wheels relative to the back support rod primary member, the rear wheel second support rod including:
a rear wheel second support rod primary member;
a rear wheel second support rod secondary member being nested within the rear wheel second support rod primary member wherein the rear wheel second support rod secondary member is extendable and retractable relative to the rear wheel second support rod primary member to adjust a length of the rear wheel second support rod; and
a rear wheel second support rod retainer being engageable with the rear wheel second support rod primary member and the rear wheel second support rod secondary member to releasably secure a position of the rear wheel second support rod secondary member relative to the rear wheel second support rod primary member, the rear wheel second support rod retainer including:
a rear wheel second support rod primary member aperture extending through the rear wheel second support rod primary member, the rear wheel second support rod primary member aperture being positioned adjacent to a junction between the rear wheel second support rod primary member and the rear wheel second support rod secondary member;
a plurality of rear wheel second support rod secondary member apertures extending through the rear wheel second support rod secondary member, the plurality of rear wheel second support rod secondary member apertures being aligned with each other, each rear wheel second support rod secondary member aperture of the plurality of rear wheel second support rod secondary member apertures being alignable with the rear wheel second support rod primary member aperture; and
a rear wheel second support rod pin being removably positionable within the rear wheel second support rod primary member aperture and an aligned one of the plurality of rear wheel second support rod secondary member apertures;
a pair of arm rests being coupled to the seat, the pair of arm rests extending upwardly from opposing lateral sides of the seat wherein the pair of arm rests are configured to support a pair of arms of the user when the user is sitting on the chair, each arm rest of the pair of arm rests including:
a pair of arm rest lateral rods each being coupled to a respective seat rod of the pair of seat rods, each arm rest lateral rod of the pair of arm rest lateral rods being perpendicular to the respective seat rod of the pair of seat rods, each arm rest lateral rod of the pair of arm rest lateral rods including:
an arm rest lateral rod primary member being positioned on the seat rod primary member of the respective seat rod;
an arm rest lateral rod secondary member being nested within the arm rest lateral rod primary member wherein the arm rest lateral rod secondary member is extendable and retractable relative to the arm rest lateral rod primary member to adjust a height of each arm rest of the pair of arm rests, the arm rest lateral rod secondary member being positioned on the seat rod secondary member of the respective seat rod, the arm rest lateral rod secondary member being spaced from the arm rest lateral rod primary member; and
an arm rest lateral rod retainer being engageable with the arm rest lateral rod primary member and the arm rest lateral rod secondary member to releasably secure a position of the arm rest lateral rod secondary member relative to the arm rest lateral rod primary member, the arm rest lateral rod retainer including:
an arm rest lateral rod primary member aperture extending through the arm rest lateral rod primary member, the arm rest lateral rod primary member aperture being positioned adjacent to a junction between the arm rest lateral rod primary member and the arm rest lateral rod secondary member;
a plurality of arm rest lateral rod secondary member apertures extending through the arm rest lateral rod secondary member, the plurality of arm rest lateral rod secondary member apertures being aligned with each other, each arm rest lateral rod secondary member aperture of the plurality of arm rest lateral rod secondary member apertures being alignable with the arm rest lateral rod primary member aperture; and
an arm rest lateral rod pin being removably positionable within the arm rest lateral rod primary member aperture and an aligned one of the plurality of arm rest lateral rod secondary member apertures;
an arm rest upper rod being coupled to and extending between the pair of arm rest lateral rods, the arm rest upper rod being parallel to the respective seat rod of the pair of seat rods, the arm rest upper rod including:
an arm rest upper rod primary member;
an arm rest upper rod secondary member being nested within the arm rest upper rod primary member wherein the arm rest upper rod secondary member is extendable and retractable relative to the arm rest upper rod primary member to adjust a length of each arm rest of the pair of arm rests; and
an arm rest upper rod retainer being engageable with the arm rest upper rod primary member and the arm rest upper rod secondary member to releasably secure a position of the arm rest upper rod secondary member relative to the arm rest upper rod primary member, the arm rest upper rod retainer including:
an arm rest upper rod primary member aperture extending through the arm rest upper rod primary member, the arm rest upper rod primary member aperture being positioned proximate to a junction between the arm rest upper rod primary member and the arm rest upper rod secondary member;
a plurality of arm rest upper rod secondary member apertures extending through the arm rest upper rod secondary member, the plurality of arm rest upper rod secondary member apertures being aligned with each other, each arm rest upper rod secondary member aperture of the plurality of arm rest upper rod secondary member apertures being alignable with the arm rest upper rod primary member aperture; and
an arm rest upper rod pin being removably positionable within the arm rest upper rod primary member aperture and an aligned one of the plurality of arm rest upper rod secondary member apertures; and
an arm rest pad being coupled to the arm rest upper rod, the arm rest pad having a width exceeding a width of the arm rest upper rod wherein the arm rest pad extends outwardly past opposing lateral edges of the arm rest upper rod;
a pair of foot rests being coupled to and extending from the seat of the chair, the pair of foot rests being angled wherein the pair of foot rests extend forwardly and downwardly from the seat and wherein the pair of foot rests are configured to support a pair of feet of the user when the user is sitting in the chair, each foot rest of the pair of foot rests including:
a foot rest primary rod being positioned proximate to the seat rod primary member forward end of the seat rod primary member of a respective seat rod of the pair of seat rods, the foot rest primary rod being pivotably coupled to a respective forward support rod of the pair of forward support rods wherein the foot rest primary rod is pivotable upwards and downwards to adjust an angle of each foot rest of the pair of foot rests relative to the seat of the chair;
a foot rest secondary rod being coupled to the foot rest primary rod, the foot rest secondary rod being nested within the foot rest primary rod wherein the foot rest secondary rod is extendable and retractable relative to the foot rest primary rod to adjust a length of each foot rest of the pair of foot rests;
a foot rest plate being coupled to the foot rest secondary rod, the foot rest plate extending outwardly from the foot rest secondary rod wherein the foot rest plate is configured to support a respective foot of the pair of feet of the user when the user is sitting in the chair; and
a foot rest retainer being engageable with the foot rest primary rod and the foot rest secondary rod to releasably secure a position of the foot rest primary rod relative to the foot rest secondary rod, the foot rest retainer including:
a foot rest primary rod aperture extending through the foot rest primary rod, the foot rest primary rod aperture being positioned adjacent to a junction between the foot rest primary rod and the foot rest secondary rod;
a plurality of foot rest secondary rod apertures extending through the foot rest secondary rod, the plurality of foot rest secondary rod apertures being aligned with each other, each foot rest secondary rod aperture of the plurality of foot rest secondary rod apertures being alignable with the foot rest primary rod aperture; and
a foot rest rod pin being removably positionable within the foot rest primary rod aperture and an aligned one of the plurality of foot rest secondary rod apertures;
a foot rest cross member being coupled to and extending between the pair of foot rests, the foot rest cross member being perpendicular to the pair of foot rests, the foot rest cross member being extendable and retractable to adjust a distance between the pair of foot rests, the foot rest cross member including:
a foot rest cross member primary shaft;
a foot rest cross member secondary shaft being nested within the foot rest cross member primary shaft wherein the foot rest cross member secondary shaft is extendable and retractable relative to the foot rest cross member primary shaft to selective adjust the distance between the pair of foot rests; and
a foot rest cross member retainer being engageable with the foot rest cross member primary shaft and the foot rest cross member secondary shaft to releasably secure a position of the foot rest cross member secondary shaft relative to the foot rest cross member primary shaft, the foot rest cross member retainer including:
a foot rest cross member primary shaft aperture extending through the foot rest cross member primary shaft, the foot rest cross member primary shaft aperture being positioned proximate to a junction between the foot rest cross member primary shaft and the foot rest cross member secondary shaft;
a plurality of foot rest cross member secondary shaft apertures extending through the foot rest cross member secondary shaft, the plurality of foot rest cross member secondary shaft apertures being aligned with each other, each foot rest cross member secondary shaft aperture of the plurality of foot rest cross member secondary shaft apertures being alignable with the foot rest cross member primary shaft aperture; and
a foot rest cross member pin being removably positionable within the foot rest cross member primary shaft aperture and an aligned one of the plurality of foot rest cross member secondary shaft apertures; and
a calf pad being coupled to and extending between the pair of foot rests, the calf pad being positioned on the foot rest secondary rod proximate to the foot rest plate of each foot rest of the pair of foot rests wherein the calf pad is configured to be alignable with a pair of calves of the user when the user is sitting in the chair.
